(19) United States
(12) Patent Application Publication
(10) Pub. No.: US 2026/0175459 A1
(43) Pub. Date: Jun. 25, 2026

(54) ELECTRIC HAIR CLIPPER WITH BLUETOOTH SPEAKER FUNCTION

(71) Applicant: Baile You, Ningbo (CN)

(72) Inventor: Baile You, Ningbo (CN)

(21) Appl. No.: 19/015,568

(22) Filed: Jan. 9, 2025

(30) Foreign Application Priority Data
Dec. 24, 2024 (CN) 202423195338.5

(51) Int. Cl. B26B 19/38; H04R 1/02

(52) U.S. Cl. CPC B26B 19/382; H04R 1/02; H04R 2420/07

(57) ABSTRACT

An electric hair clipper with a Bluetooth speaker function comprises an electric hair clipper body, wherein a speaker is mounted in the electric hair clipper body and electrically connected to a circuit board in the electric hair clipper body, and a Bluetooth module is mounted on the circuit board in the electric hair clipper body; a speaker hole is formed in a shell side wall of the electric hair clipper body and corresponds to the speaker in position. The electric hair clipper is practical and novel in structure, has a Bluetooth speaker function, can play music, can realize quick audio connection, and is particularly suitable for infants.

### CROSS-REFERENCE TO RELATED APPLICATION

This application claims priority of Chinese Patent Application No. 202423195338.5, filed on Dec. 24, 2024, the entire contents of which are incorporated herein by reference.

### TECHNICAL FIELD

The disclosure relates to an electric hair clipper, in particular to an electric hair clipper with a Bluetooth speaker function.

### DESCRIPTION OF RELATED ART

Electric hair clippers are common tools used by people to cut hair. Existing electric hair clippers have only one function, for example, they only have a hair cutting function and do not have a music playing function. Particularly, when electric hair clippers are used to cut hair for some infants, the buzz of the electric hair clippers easily scares the infants, making the infants cry, restless and unwilling to cut hair.

### BRIEF SUMMARY OF THE INVENTION

The technical issue to be settled by the disclosure is to provide an electric hair clipper with a Bluetooth speaker function to overcome the defects in the prior art.

To fulfill the above objective, the disclosure adopts the following measure:

An electric hair clipper with a Bluetooth speaker function comprises an electric hair clipper body, wherein a speaker is mounted in the electric hair clipper body and electrically connected to a circuit board in the electric hair clipper body, and a Bluetooth module is mounted on the circuit board in the electric hair clipper body;
a speaker hole is formed in a shell side wall of the electric hair clipper body and corresponds to the speaker in position.

The disclosure has the following beneficial effects: the electric hair clipper is practical and novel in structure, has a Bluetooth speaker function, can play music, can realize quick audio connection, and is particularly suitable for infants.

### BRIEF DESCRIPTION OF THE SEVERAL VIEWS OF THE DRAWINGS

FIG. 1 is an external structural view according to the disclosure.

FIG. 2 is an exploded structural view according to the disclosure.

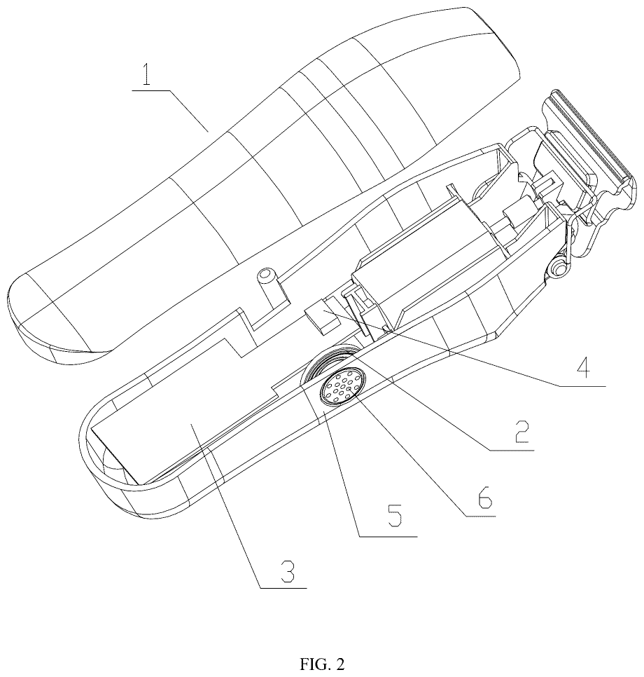

### DETAILED DESCRIPTION OF THE INVENTION

An electric hair clipper with a Bluetooth speaker function comprises an electric hair clipper body 1, wherein a speaker 2 is mounted in the electric hair clipper body 1 and electrically connected to a circuit board 3 in the electric hair clipper body 1, and a Bluetooth module 4 is mounted on the circuit board 3 in the electric hair clipper body 1.

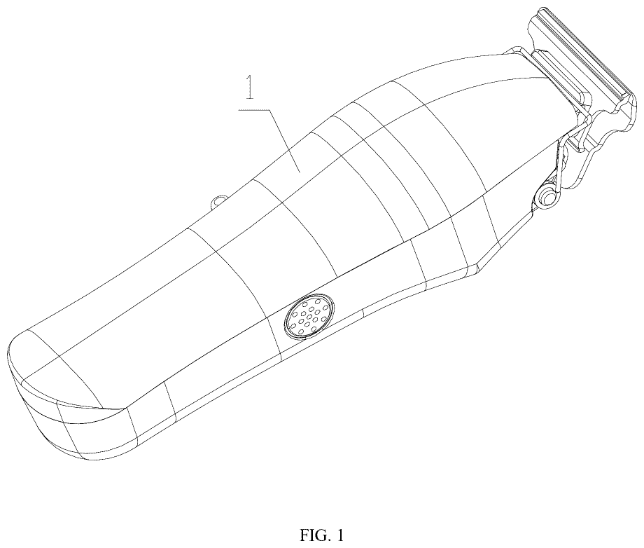

As shown in FIG. 1, the electric hair clipper provided by the disclosure is connected to an electronic product such as a mobile phone by means of the Bluetooth module 4, and when music is played by the mobile phone, the music will be played by the speaker 2 of the electric hair clipper body 1, such that the interestingness of the electric hair clipper is improved. The electric hair clipper provided by the disclosure is particularly suitable for infants. People with infant care experience know that when an electric hair clipper is used to cut hair for infants, the buzz of the electric hair clipper easily scares the infants, making the infants to cry. When used for cutting hair for infants, the electric hair clipper body 1 in the disclosure can play children's songs to pacify the infants to complete a haircut smoothly.

The electric hair clipper body 1 is rechargeable. A switch and a speaker hole 6 of the electric hair clipper body 1 are located on two sides of the electric hair clipper body 1 respectively.

The speaker hole 6 is formed in a shell side wall 5 of the electric hair clipper body 1 and corresponds to the speaker 2 in position.

1. An electric hair clipper with a Bluetooth speaker function, comprising an electric hair clipper body (1), wherein a speaker (2) is mounted in the electric hair clipper body (1) and electrically connected to a circuit board (3) in the electric hair clipper body (1), and a Bluetooth module (4) is mounted on the circuit board (3) in the electric hair clipper body (1).

2. The electric hair clipper with a Bluetooth speaker function according to claim 1, wherein a speaker hole (6) is formed in a shell side wall (5) of the electric hair clipper body (1) and corresponds to the speaker (2) in position.
